(19) United States
(12) Patent Application Publication
(10) Pub. No.: US 2023/0109738 A1
(43) Pub. Date: Apr. 13, 2023

(54) DUST-PROOF ASSEMBLY, ELECTRONIC DEVICE AND SMART WATCH

(71) Applicant: GUANGDONG OPPO MOBILE TELECOMMUNICATIONS CORP., LTD., Dongguan (CN)

(72) Inventors: Jingzhuo GENG, Dongguan (CN); Jianghua HU, Dongguan (CN)

(21) Appl. No.: 18/065,163

(22) Filed: Dec. 13, 2022

Related U.S. Application Data
(63) Continuation of application No. PCT/CN2021/091708, filed on Apr. 30, 2021.

(30) Foreign Application Priority Data
Jun. 29, 2020 (CN) 202010611589.4
Jun. 29, 2020 (CN) 202021244638.7

(51) Int. Cl. G04B 37/08; G04G 17/08; H04R 1/02

(52) U.S. Cl. CPC G04B 37/087; G04G 17/08; H04R 1/023

(57) ABSTRACT

A dust-proof assembly includes a dust-proof net and a sealing net. The sealing net includes a support portion and a flexible sealing body, and the support portion is provided with a plurality of through holes. The dust-proof net and the support portion are arranged opposite each other, and the dust-proof net is connected to the support portion. The flexible sealing body is connected to the support portion and at least partially protrudes out of the dust-proof net.

### CROSS-REFERENCE OF RELATED APPLICATIONS

This application is a continuation of International Application No. PCT/CN2021/091708, filed Apr. 30, 2021, which claims priority to Chinese Patent Application No. CN202010611589.4, filed Jun. 29, 2020, and claims priority to Chinese Patent Application No. CN202021244638.7, filed Jun. 29, 2020. The entire disclosures of the aforementioned applications are incorporated herein by reference.

### TECHNICAL FIELD

The disclosure relates to the field of dust-proof technologies, and more particularly to a dust-proof assembly, an electronic device, and a smart watch.

### BACKGROUND

At present, with the rapid development of electronic devices such as watches, the electronic devices are becoming more and more intelligent, especially multi-functional smart watches, mobile terminals, and other electronic devices, which are more popular and gradually inseparable from people's lives. For example, in recent years, the development of the smart watches has become increasingly hot, and various smart device manufacturers have successively launched various smart watches.

Electronic devices such as the mobile terminals and the smart watches are usually equipped with electroacoustic components such as microphones and loudspeakers. These components need to be equipped with sound holes, and external dust may enter these holes, causing blockage.

### SUMMARY

A purpose of the present disclosure is to provide a dust-proof assembly, an electronic device, and a smart watch.

In a first aspect, an embodiment of the present disclosure provides a dust-proof assembly, including a dust-proof net and a sealing net. The sealing net includes a support portion and a flexible sealing body. The support portion is disposed with a plurality of through holes. The dust-proof net and the support portion are arranged opposite each other, and the dust-proof net is connected to the support portion. The flexible sealing body is connected to the support portion and at least partially protrudes out of the dust-proof net.

In a second aspect, an embodiment of the present disclosure provides an electronic device, including a housing, an electroacoustic component, and the above-mentioned dust-proof assembly. The housing is disposed with a sound hole, the electroacoustic component is disposed in the housing and configured to transmit sound through the sound hole, the dust-proof assembly is disposed in the housing, the flexible sealing body is connected to the housing, and the dust-proof net is disposed facing towards the sound hole and completely covers the sound hole.

In a third aspect, an embodiment of the present disclosure provides a smart watch, including a housing, an electroacoustic component, and the above-mentioned dust-proof assembly. The housing is disposed with a sound hole, the electroacoustic component is disposed in the housing and configured to transmit sound through the sound hole, the dust-proof assembly is disposed in the housing, the flexible sealing body is connected to the housing, and the dust-proof net is disposed facing towards the sound hole and completely covers the sound hole.

These or other aspects of the present disclosure will be more concise and understandable in the following description of embodiments.

### BRIEF DESCRIPTION OF DRAWINGS

In order to illustrate technical solutions in embodiments of the present disclosure more clearly, the drawings used in the description of the embodiments are briefly described below. Apparently, the drawings in the following description are merely some embodiments of the present disclosure, and for those skilled in the art, other drawings may be obtained according to these drawings without paying any creative effort.

FIG. 1 illustrates a schematic structural view of a disassembled structure of an electronic device according to an embodiment of the present disclosure.

FIG. 2 illustrates a cross-sectional view of the electronic device illustrated in FIG. 1.

FIG. 3 illustrates an enlarged schematic structural view of a structure at portion III illustrated in FIG. 2.

FIG. 4 illustrates a schematic structural view of a disassembled structure of a dust-proof assembly according to an embodiment of the present disclosure.

FIG. 5 illustrates a schematic structural view of a disassembled structure of a sealing net of the dust-proof assembly in the embodiment illustrated in FIG. 4.

FIG. 6 illustrates a schematic cross-sectional view of the dust-proof assembly according to the embodiment of the present disclosure.

### DETAILED DESCRIPTION OF EMBODIMENTS

Technical solutions in embodiments of the present disclosure will be clearly and completely described below with reference to the drawings in the embodiments of the present disclosure. Apparently, the described embodiments are merely some of the embodiments of the present disclosure, but not all of them. Based on the embodiments in the present disclosure, all other embodiments obtained by those skilled in the art without creative labor belong to the scope of protection in the present disclosure.

The existing electronic devices such as smart watches are usually equipped with electroacoustic components, so that sound holes are required to be formed on the housings of the electronic devices such as the smart watches. Because of the sound holes, dust in the air may enter the electronic devices from the sound holes, causing adverse effects on components in the electronic devices. When the existing dust-proof assembly is installed, the dust-proof assembly needs to be attached to the housing of the electronic device separately, and additional waterproof sealing elements need to be arranged to achieve waterproof, and thus the assembly process is complex.

Therefore, the inventor proposes a dust-proof assembly, an electronic device, and a smart watch in the embodiments of the present disclosure. The embodiments of the present disclosure will be described in detail below in conjunction with the accompanying drawings.

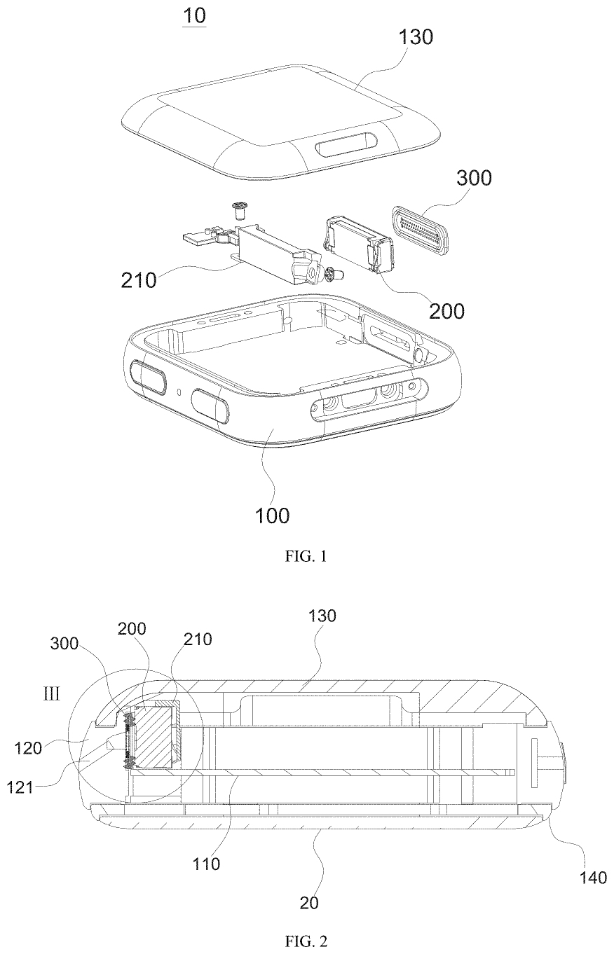

As illustrated in FIG. 1, an embodiment provides an electronic device 10. Specifically, the electronic device 10 may be a mobile phone or a smart phone (e.g., a phone based on iPhone™ or Android™), a portable game device (e.g., Nintendo DS™, PlayStation Portable™, Gameboy Advance™, iPhone™), a laptop computer, a personal digital assistant (PDA), a portable Internet device, a music player, a data storage device, or one of other handheld devices such as a watch, a headphone, a pendant, an earphone, etc. The electronic device 10 may also be one of other wearable devices (e.g., a head-mounted device (HMD) such as electronic glasses, an electronic cloth, an electronic bracelet, an electronic necklace, an electronic tattoo, a smart watch). In this embodiment, only as an example, the electronic device 10 is the smart watch, and the smart watch is taken as an example for description below.

The electronic device 10 includes a housing 100, a watch band (not illustrated in the drawings), an electroacoustic component 200, and a dust-proof assembly 300. The watch band is connected to the housing 100 and is used for a user to wear on a wrist. The electroacoustic component 200 and the dust-proof assembly 300 are both disposed in the housing 100, and the dust-proof assembly 300 is used for preventing the electroacoustic component 200 from dust.

As illustrated in FIG. 1 and FIG. 2, the housing 100 includes a middle plate 110 and a frame 120. The frame 120 is surrounded on the middle plate 110 and connected to the middle plate 110. The middle plate 110 may be used to disposed with various types of components, such as a main board, a chip, a battery, etc. The frame 120 may be used to form structures such antennas, control buttons, etc. In some embodiments, the middle plate 110 may be configured into various shapes, such as a substantially circular shape, an oval shape, an oblong shape, a square shape, a polygonal shape, and the like. Correspondingly, the frame 120 surrounds the middle plate 110 and is connected to an edge of the middle plate 110, and a shape enclosed by the frame 120 is matched with the middle plate 110. The watch band may be made of various materials such as metal, plastic, leather, artificial leather, etc., which are not limited here, and the watch band may be disposed in a form of adjustable length to fit to different users' wrists.

As illustrated in FIG. 2, the housing 100 is disposed with a sound hole 121, the sound hole 121 penetrates through the frame 120, and the sound hole 121 is used to transmit sound and form a channel for acoustic wave transmission. The sound hole 121 may be a circular hole, an oblong hole, etc., and is not limited here. The electroacoustic component 200 is disposed in the housing 100 and configured to transmit sound through the sound hole 121. The electroacoustic component 200 may be a sound receiving element, such as a microphone, in which the external sound can enter the housing 100 through the sound hole 121 and be received by the microphone. The electroacoustic component 200 may also be a sound emitting element, such as a loudspeaker, in which the sound emitted by the loudspeaker can be transmitted to the outside of the housing 100 through the sound hole 121.

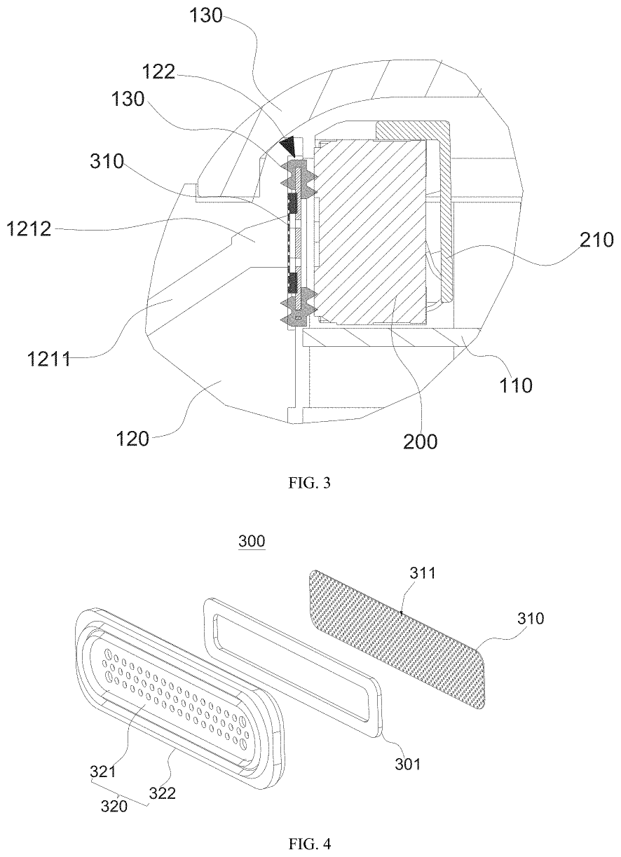

As an embodiment, referring to FIG. 3, the sound hole 121 is defined on the frame 120. The sound hole 121 includes a first hole portion 1211 and a second hole portion 1212 intercommunicated with each other. The first hole portion 1211 penetrates an outer surface of the frame 120, the second hole portion 1212 penetrates an inner surface of the frame 120, and an extension direction of the first hole portion 1211 is bent relative to the second hole portion 1212. The advantages of this arrangement are that since the sound hole 121 is not arranged along a straight line as a whole, and there are bends formed in the sound hole 121. Therefore, when external dust and impurities enter the first hole portion 1211 of the sound hole 121, they will not easily move to the second hole portion 1212, and finally enter the interior of the housing 100, thus avoiding the accumulation of impurities at the dust-proof assembly 300, and improving the dust-proof and waterproof effects. It can be understood that in other embodiments, the sound hole 121 may be bent at least twice, so as to further prevent external dust, impurities, and the like from entering a position close to the dust-proof assembly 300 to form accumulation. In other embodiments, the sound hole 121 may be extended along a straight line without bending.

As illustrated in FIG. 2 and FIG. 4, the dust-proof assembly 300 includes a dust-proof net 310 and a sealing net 320. The dust-proof net 310 is disposed with multiple guide holes 311, for example, hole sizes of the guide holes 311 may be in a range of 0.5-5 micrometers (mm). The multiple guide holes 311 are spaced, and the multiple guide holes 311 may be arranged regularly or irregularly. The dust-proof net 310 may be made of metal, plastic or other materials or formed by weaving, and may form an approximate plate structure. The configuration of the dust-proof net 310 may be matched with a cross section of the sound hole 121, so that the dust-proof net 310 may completely cover the sound hole 121. In addition, the dust-proof net 310 may have a slightly larger cross-sectional area than the sound hole 121.

As illustrated in FIG. 4 and FIG. 5, the sealing net 320 includes a support portion 321 and a flexible sealing body 322. As an implementation, the support portion 321 includes a center portion 3211 and an edge portion 3212. The edge portion 3212 surrounds the center portion 3211 and is connected to the center portion 3211. The center portion 3211 and the edge portion 3212 may be integrally formed to form a smooth connection. Of course, it can be understood that the center portion 3211 and the edge portion 3212 may also be connected by welding or the like. In some embodiments, a cross-sectional area of the center portion 3211 may be roughly equivalent to that of the dust-proof net 310, the edge portion 3212 is roughly annular, and a width of the edge portion 3212 along a radial direction of the support portion 321 is significantly less than that of the center portion 3211. For example, the radial width of the edge portion 3212 is less than or equal to ⅕ of the radial width of the center portion 3211, and it is understood that ⅕ is only an example, and other values are also possible. The support portion 321 may, for example, be made of metal material, so that the support portion 321 has enough rigidity to support the entire dust-proof assembly 300. In addition, the rigid support portion 321 may also play a role of preventing penetration. When an external sharp object is inserted into the sound hole 121, the entire dust-proof assembly 300 will not be penetrated, so as to prolong the service life and prevent a user from mistakenly inserting a needle-like tool (also referred to as poking pin or eject pin) into the sound hole 121 when removing a subscriber identity module (SIM) card holder with the needle-like tool.

In this embodiment, the support portion 321 is substantially in an oblong structure and is matched with the sound hole 121. It can be understood that in other embodiments, the shape and structure of the support portion 321 may be adaptively adjusted, which is not limited herein. The center portion 3211 is disposed with multiple through holes 3213, and the multiple through holes 3213 may be arranged regularly or irregularly. In some embodiments, the through holes 3213 on the center portion 3211 may have the same number as the guide holes 311 on the dust-proof net 310, and the through holes 3213 corresponds to the guide holes 311 in one-by-one manner. In this situation, the advantage of this arrangement is that, since the through holes 3213 and the guide hole 311 are arranged in one-to-one correspondence, when the sound is transmitted to the dust-proof assembly 300, the sound wave can always be transmitted along a straight line, thereby avoiding greater loss of sound energy due to collision with the dust-proof assembly during the transmission process, and improving the sound guiding effect. In some embodiments, the through holes 3213 on the center portion 3211 may be staggered with the guide holes 311 on the dust-proof net 310, which means that an axis of any one of the through holes 3213 does not coincide with an axis of any one of the guide holes 311. In this situation, the advantage of this arrangement is that when fine dust, impurities, and the like from outside pass through the dust-proof net 310, it is difficult to pass through the center portion 3211 of the sealing net 320 at the same time, so that the dust-proof effect can be improved. It should be noted that the hole sizes of through holes 3213 may be the same as or different from that of the guide holes 311.

The hole sizes of the multiple through holes 3213 may be completely different, partially the same, partially different, or completely the same. In this embodiment, among the multiple through holes 3213, the hole sizes of some of the through holes 3213 adjacent to the edge portion 3212 are larger than that of other through holes 3213. The purpose of this arrangement is that in the process of manufacturing the support portion 321, the through holes with a larger hole size may be formed by stamping, the support portion 321 can be positioned by using the larger through holes formed by stamping, and then several through holes 3213 with a smaller hole size may be formed on the center portion 3211 by corrosion or etching. The smaller the hole size, the better the dust-proof effect of the sealing net 320, which can further improve the dust-proof effect.

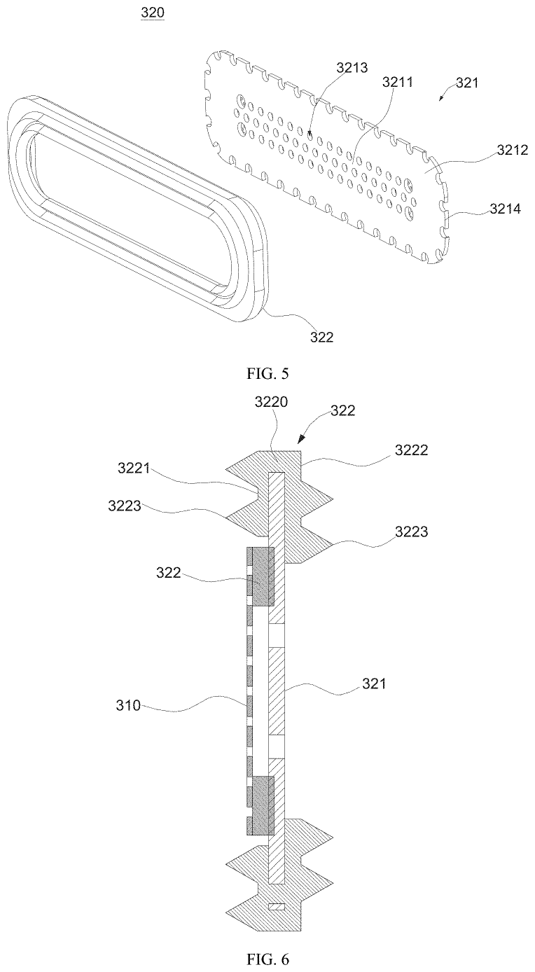

As illustrated in FIG. 4 and FIG. 6, the flexible sealing body 322 is connected to the support portion 321 and at least partially protrudes out of the dust-proof net 310, so that when applied to the electronic device 10, a portion of the flexible sealing body 322 protruding out of the dust-proof net 310 may be attached to the housing 100 to form a sealing structure. It can be understood that the portion of the flexible sealing body 322 protruding out of the dust-proof net 310 means that the flexible sealing body 322 has a portion protruding out of the dust-proof net 310, and the portion protruding out of the dust-proof net 310 may be used to fit with the housing of the electronic device to form a seal. In some embodiments, the flexible sealing body 322 may protrude from the dust-proof net 310 over the entire area surrounding the dust-proof net 310, and in this case, the portion protruding from the dust-proof net 310 may provide better sealing performance when fitting with the housing 100. In other embodiments, the flexible sealing body 322 may also protrude from the dust-proof net 310 over a portion of the entire area surrounding the dust-proof net 310, for example, forming a serrated structure and protruding from dust-proof net 310 at intervals. In some embodiments, the flexible sealing body 322 may be directly connected to a side of the support portion 321 facing toward the dust-proof net 310 and disposed around the dust-proof net 310. As an implementation, the flexible sealing body 322 may be connected to the edge portion 3212 of the support portion 321.

The flexible sealing body 322 is made of a flexible material, and thus has a certain deformability. The flexible sealing body 322 may be made of, for example, silicone or other flexible plastic glue, and may be combined with the edge portion 3212 by injection molding, so that the connection between the flexible sealing body 322 and the support portion 321 is tighter, avoiding the formation of large gaps, and further improving the dust-proof effect.

In some embodiments, the flexible sealing body 322 may include a first flexible body 3221 and a second flexible body 3222. The first flexible body 3221 is disposed on a surface of the support facing toward the dust-proof net 310, the first flexible body 3221 is disposed around the dust-proof net 310 and protrudes out of the dust-proof net 310, and the second flexible body 3222 is disposed on a surface of the support facing away from the dust-proof net 310. Specifically, the first flexible body 3221 may be used to fit with the housing, and the second flexible body 3222 may be used to fit the electroacoustic component 200. In this situation, the dust-proof assembly 300 may form a better sealing structure between the housing 100 and the electroacoustic component 200, so that it has a good sealing effect on a path of the sound wave transmitted into the electroacoustic component 200 through the sound hole or from the electroacoustic component 200. As an implementation, the first flexible body 3221 may be connected to the edge portion 3212, the second flexible body 3222 may also be connected to the edge portion 3212, and the first flexible body 3221 and the second flexible body 3222 may be substantially symmetrical. It can be understood that in other embodiments, the second flexible body 3222 may not be provided.

In some embodiments, the flexible sealing body 322 may further include a connection portion 3220, the connection portion 3220 is connected between the first flexible body 3221 and the second flexible body 3222 and covers a side edge of the support portion 321, that is, the first flexible body 3221, the second flexible body 3222 and the connection portion 3220 form a groove-like structure, the edge portion of the support portion 321 is embedded in the groove-like structure and is relatively fixed with the flexible sealing body 322, and the through holes of the center portion 3211 is located in an annular area enclosed by the first flexible body 3221 and the second flexible body 3222. The flexible sealing body 322 forms a covering structure for the edge portion 3212, and since the first flexible body 3221 surrounds and protrudes out of the dust-proof net 310, the flexible sealing body 322 can also protect the dust-proof net 310. In other embodiments, the connection portion 3220 may not be provided, and the first flexible body 3221 and the second flexible body 3222 may be directly connected to the edge portion 3212 by means of adhesion or the like.

As illustrated in FIG. 5 and FIG. 6, as an implementation, in order to further improve the binding force between the flexible sealing body 322 and the support portion 321, an edge of the edge portion 3212 is disposed with multiple serrations 3214 protruding from the edge portion 3212 along a radial direction of the edge portion 3212. By setting the serrations 3214, the serrations 3214 may be embedded in the connection portion to form a more stable connection structure when the connection portion covers the side edge of the support portion.

In some embodiments, the flexible sealing body 322 and the support portion 321 may be integrally combined by injection molding, so as to enhance the connection strength between the flexible sealing body 322 and the support portion 321, and to avoid forming a gap between the flexible sealing body 322 and the support portion 321, thereby enhancing the sealing performance. In particular, when the flexible sealing body 322 includes the connection portion 3220 and the support portion 321 is disposed with the serrations 3214, during the injection molding process, the plastic forming the flexible sealing body 322 can flow between two adjacent serrations 3214 and be combined with the serrations 3214. In this way, the serrations 3214 are embedded in the flexible sealing body 322 and the flexible sealing body 322 is embedded between adjacent serrations 3214, so that a structure similar to a mortise and tenon is formed, and the bonding force is larger and more stable.

In some embodiments, an end of each of the serrations 3214 away from the support portion 321 may form a barb-shaped structure, the barb-shaped structure refers to a slight hook-shaped structure formed by the end of each of the serrations 3214 away from the support portion 321, similar to a barb of a fish hook, which can better improve the binding force between the flexible sealing body 322 and the support portion 321, and prevent the flexible sealing body 322 from falling off from the support portion 321. The serrations 3214 and the through holes 3213 may be formed on the support portion 321 by stamping or the like.

It should be noted that the flexible sealing body 322 may be connected to the support portion 321 by means of adhesion or the like.

As illustrated in FIG. 6, the dust-proof net 310 and the sealing net 320 are arranged opposite each other, and the dust-proof net 310 is spaced with the center portion 3211, and a cavity is defined between the dust-proof net 310 and the support portion 321. In this situation, the cavity can play the role of accommodating part of the dust, when the external dust enters the cavity through the dust-proof net 310, the dust may be scattered and deposited in the cavity due to the enlarged space, instead of directly entering the housing 100 through the through hole 3213, and thus the dust will not enter the electroacoustic component 200. Specifically, the dust-proof net 310 substantially corresponds to the center portion 3211, that is, an orthographic projection of the dust-proof net 310 on the support portion 321 substantially coincides with the center portion 3211.

In some embodiments, the dust-proof assembly 300 further includes an adhesive layer 301, the dust-proof net 310 is adhered to the center portion 3211 of the support portion 321 through the adhesive layer 301, the adhesive layer 301 is only disposed in a partial area of the support portion 321, and the adhesive layer 301 is disposed around the multiple through holes 3213, so that the through holes 3213 can be exposed. Since the adhesive layer 301 only exists in the partial area of the support portion 321, a spacing is formed between the dust-proof net 310 and the center portion 3211 of the support portion 321, and a width of the spacing is the same as a thickness of the adhesive layer 301. Since the dust-proof net 310 is spaced from the support portion 321, a cavity is jointly defined among the adhesive layer 301, the dust-proof net 310 and the support portion 321, which has the advantage that even if fine dust or impurities enter the dust-proof assembly 300 through the guide holes 311, the fine dust or impurities will be deposited in the cavity between the dust-proof net 310 and the support portion 321, instead of entering the housing 100 through the through holes 3213. While the adhesive layer 301 is sticky, the dust is adsorbed when approaching to the adhesive layer 301, and the dust entering the cavity will not block the through holes 3213, which can not only improve the dust-proof effect, but also ensure the quality of sound wave conduction. In addition, due to the existence of the cavity, when the electroacoustic component 200 produces sound, the sound wave is transmitted into the cavity through the through holes 3213 or the guide holes 311, forming an echo effect, which can improve the sound effect.

In order to reduce the volume occupied by the dust-proof assembly 300, the spacing between the dust-proof net 310 and the sealing net 320 may be set to be less than a length in a range of 1-2 mm, for example. On the one hand, the adhesive layer 301 with the above thickness can ensure sufficient adhesion force between the dust-proof net 310 and the sealing net 320. On the other hand, if the spacing is too large, the thickness of the dust-proof assembly 300 will be too large, which will occupy a lot of space inside the electronic device 10.

In some embodiments, the spacing between the dust-proof net 310 and the center portion 3211 is less than or equal to the thickness of the flexible sealing body 322, and the flexible sealing body 322 is in contact with an outer periphery of the dust-proof net 310 when being injection-molded with the support portion 321. After such setting, it is equivalent to that the outer periphery of the dust-proof net 310 is embedded in the flexible sealing body 322, further improving the sealing performance of the dust-proof assembly 300.

In other embodiments, the space between the dust-proof net 310 and the support portion 321 may be completely filled by the adhesive layer 301, and only the through holes 3213 and the guide holes 311 are communicated in hole-like structures. In this way, the connection strength between the dust-proof net 310 and the support portion 321 can be increased, and the stability of the whole dust-proof assembly 300 can be improved. In this situation, as the adhesive amount of the adhesive layer 301 is increased, when dust enters between the dust-proof net 310 and the support portion 321, the dust will be absorbed by the adhesive layer 301, thereby improving the dust-proof effect.

In some embodiments, the dust-proof net 310 may also be connected to the support portion 321 by welding, for example, the edge of the dust-proof net 310 is welded to the support portion 321 by lap welding, and a cavity may also be formed between the dust-proof net 310 and the support portion 321.

When in use, the dust-proof net 310 of the dust-proof assembly 300 is attached to the frame 120 and completely covers the sound hole 121, so that the dust, impurities, etc. entering the housing 100 from the sound hole 121 will be blocked by the dust-proof net 310. In order to improve the sealing performance of the dust-proof assembly 300, the first flexible body 3221 of the flexible sealing body 322 also abuts against the frame 120 during installation, so as to improve the sealing performance. Therefore, in some embodiments, when the flexible sealing body 322 is in a natural state, the first flexible body 3221 of the flexible sealing body 322 protrudes from or is flush with the surface of the dust-proof net 310 away from the support portion 321, so that when the dust-proof net 310 is attached to the frame 120 of the electronic device 10, the flexible sealing body 322 is also attached to the frame 120, forming a double sealing effect. Since the flexible sealing body 322 is a non-porous and compact structure, and is integrally enclosed on the outside of the dust-proof net 310, and the flexible sealing body 322 can play a waterproof role after being attached to the frame 120 of the housing 100, so as to achieve the dual-proof effect of the dust-proof assembly 300.

As an embodiment, the first flexible body 3221 or the second flexible body 3222 forms at least one convex rib 3223. It can be understood that the convex rib 3223 may be formed only on the first flexible body 3221 or only on the second flexible body 3222. In this embodiment, the convex ribs 3223 are formed on the first flexible body 3221 and the second flexible body 3222, and the convex ribs 3223 protrude from the first flexible body 3221 and the second flexible body 3222 along an axis direction of the through holes 3213, respectively. The convex rib 3223 on the first flexible body 3221 and the convex rib 3223 on the second flexible body 3222 protrude in mutually opposite directions. In addition, the first flexible body 3221 may be disposed with one or multiple convex ribs 3223, and the multiple convex ribs 3223 may be arranged side by side. In some embodiments, each convex rib 3223 is annular and is disposed around the center portion 3211. In other embodiments, each convex rib 3223 may also be an intermittent multi-segment structure and is disposed around the center portion 3211.

As illustrated in FIG. 3 and FIG. 6, the convex rib 3223 on the first flexible body 3221 protrudes from the surface away from the support portion 321 of the dust-proof net 310. In this way, when the dust-proof net 310 is attached to the frame 120 of the electronic device 10, the convex rib 3223 on the first flexible body 3221 of the flexible sealing body 322 is also attached to the frame 120 and is expanded. The convex rib 3223 on the second flexible body 3222 may also be closely attached to the electroacoustic component 200 to form a seal. When the sound wave passes through the dust-proof assembly 300, the sound wave is prevented from propagating in other directions, can only enter the sound holes 121 through the through holes 3213, the guide holes 311 and the like to propagate outwards; or enter the guide holes 311 and through holes 3213 from the sound hole 121 to the sound device.

A longitudinal cross section of the convex rib 3223 may be rectangular or may be configure into other shapes. As an implementation, the longitudinal cross section of the convex rib 3223 may be configured into a spike shape, a cone shape, a conical frustum shape, or the like away from the support portion 321. The advantage of such configuration is that when the convex rib 3223 abuts against the housing 100 or the electroacoustic component 200, the flexible sealing body 322 may have better deformability, so that the flexible sealing body 322 can be better attached to the housing 100 or the electroacoustic component 200, thereby providing better sealing performance.

In the above dust-proof assembly 300, the sealing net 320 may form a sealing structure directly from the support portion 321 and the flexible sealing body 322, and the dust-proof net 310 and the sealing net 320 may be connected together in advance, so that the dust-proof net 310 and the sealing net 320 can be modularly produced during production and assembly. When applied to the electronic device 10 such as the smart watch, the dust-proof assembly 300 can be directly assembled as a whole, making assembly easier. In addition, since the flexible sealing body 322 can be in contact with the housing 100 of the electronic device 10 and the electroacoustic component 200 at the same time, the sealing performance of the dust-proof assembly 300 can be improved, thereby achieving better waterproof and dust-proof effects.

As illustrated in FIG. 2 and FIG. 3, in this embodiment, the electroacoustic component 200 is disposed on the middle plate 110 and abuts against the second flexible body 3222 of the flexible sealing body 322 to form a seal. In some embodiments, the dust-proof assembly 300 may be directly attached to the frame 120 through the adhesive layer 301 and abut against the frame 120 to make the dust-proof net 310 cover the sound hole 121. In this embodiment, the microphone is disposed on the middle plate 110 and the dust-proof assembly 300 is entirely pressed against the frame 120, so that the dust-proof net 310 covers the sound hole 121, that is, the dust-proof assembly 300 does not need to be connected to the frame 120 through the adhesive layer 301, and is fixed on the frame 120 only by the pressing force of the electroacoustic component 200, which can reduce the use of the adhesive layer 301 and the thickness of the dust-proof assembly 300 during the overall assembly.

As illustrated in FIG. 1 and FIG. 2, as an implementation, the electronic device 10 further includes a bracket 210, the bracket 210 is mounted on the middle plate 110, and the electroacoustic component 200 is assembled on the bracket 210 to be fixed. The bracket 210 may be configured into a structure matched with the electroacoustic component 200. During installing, the sound inlet/outlet of the electroacoustic component 200 is disposed facing towards the sealing net 320, and the second flexible body 3222 of the flexible sealing body 322 abuts against the electroacoustic component 200 to form a seal.

In some embodiments, as illustrated FIG. 3, in order to further reduce the space occupied by the dust-proof assembly 300, a groove 122 is defined on an inner surface of the frame 120, the sound hole 121 is defined on the frame 120 and communicated with the groove 122, and the dust-proof assembly 300 is at least partially disposed in the groove 122. In this case, on the one hand, it is convenient for positioning the dust-proof assembly 300, on the other hand, it can reduce the space where the dust-proof assembly 300 intrudes into the interior of the housing 100. In this situation, due to the limitation of the groove 122, the degree of freedom of the dust-proof assembly 300 is affected, and the dust-proof assembly 300 can be completely fixed only by the electroacoustic component 200 pressing against the dust-proof assembly 300. In some embodiments, the dust-proof net 310 and at least part of the flexible sealing body 322 are disposed in the groove 122 and are closely attached to the frame 120. In this embodiment, the entire dust-proof assembly 300 is disposed in the groove 122 and is pressed against the electroacoustic component 200.

As illustrated FIG. 2, the housing 100 further includes a front housing 140 and a rear cover 130. The front housing 140 and the rear cover 130 are assembled on opposite sides of the middle plate, form an accommodation space together with the middle plate for accommodating various components, and the electroacoustic component 200 is accommodated in the accommodation space. The electronic device may further include a display screen 20 mounted on a side of the front housing 140 of the housing 100 and is assembled with the front housing 140. In some embodiments, the sound hole 121 may also be defined on the front housing 140 or the rear cover 130, further reducing the opening on the frame 120.

In addition, the electronic device 10 further includes a main board (not illustrated in the drawings). The main board is disposed in the accommodation space, the main board is used to install various types of electrical components and is electrically connected to the display screen 20 and the electroacoustic component 200. Specifically, it can be understood that the display screen 20 in this embodiment may be one or more, although not illustrated in the drawings, the electronic device 10 in this embodiment may further include more or fewer components, such as cameras, antennas, and other components.

The electronic device 10 provided in this embodiment may be the smart watch, the mobile terminal, etc. The dust-proof assembly 300 is installed in the electronic device 10 for dust-proof installation of the sound hole 121. Because the dust-proof assembly 300 is a modular structure, the assembly process is simple, and the waterproof and dust-proof sealing performance is better.

The above description is only a preferred embodiment of the present disclosure, and is not intended to limit the present disclosure. It will be apparent to those skilled in the art that various modifications and variations are possible in the present disclosure. Any modification, equivalent substitution, improvement, etc. within the spirit and principle of the present disclosure shall be included in the scope of protection of the present disclosure.

What is claimed is:

1. A dust-proof assembly, comprising:
a dust-proof net; and
a sealing net, comprising a support portion and a flexible sealing body, wherein the support portion is disposed with a plurality of through holes, the dust-proof net and the support portion are arranged opposite each other, the dust-proof net is connected to the support portion, and the flexible sealing body is connected to the support portion and at least partially protrudes out of the dust-proof net.

2. The dust-proof assembly according to claim 1, wherein a cavity is defined between the dust-proof net and the support portion, and the plurality of through holes are communicated with the cavity.

3. The dust-proof assembly according to claim 2, wherein a spacing defined between the dust-proof net and the support portion, and the spacing is less than a length in a range of 1-2 millimeters (mm).

4. The dust-proof assembly according to claim 1, further comprising:
an adhesive layer, wherein the dust-proof net is adhered to the support portion through the adhesive layer, and the adhesive layer is disposed around the plurality of through holes.

5. The dust-proof assembly according to claim 4, wherein an outer periphery of the dust-proof net is in contact with the flexible sealing body.

6. The dust-proof assembly according to claim 1, wherein the flexible sealing body comprises a first flexible body and a second flexible body, the first flexible body is disposed on a surface of the support portion facing towards the dust-proof net, the first flexible body is disposed around the dust-proof net and protrudes from the dust-proof net, and the second flexible body is disposed on a surface of the support portion facing away from the dust-proof net.

7. The dust-proof assembly according to claim 6, wherein the flexible sealing body further comprises a connection portion, and the connection portion is connected between the first flexible body and the second flexible body and covers a side edge of the support portion.

8. The dust-proof assembly according to claim 7, wherein the flexible sealing body and the support portion are combined by injection molding.

9. The dust-proof assembly according to claim 7, wherein the side edge of the support portion is disposed with a plurality of serrations, the plurality of serrations protrude out of the side edge along a radial direction of the support portion, and the plurality of serrations are embedded in the connection portion.

10. The dust-proof assembly according to claim 9, wherein the support portion comprises a center portion and an edge portion, the edge portion is disposed around the center portion, the plurality of through holes are disposed at the center portion, the plurality of serrations are formed at the edge portion, and hole sizes of the through holes of the plurality of through holes near the edge portion are larger than hole sizes of the through holes of the plurality of through holes far away from the edge portion.

11. The dust-proof assembly according to claim 6, wherein the first flexible body and the second flexible body are formed with convex ribs, and the convex ribs on the first flexible body and the convex ribs on the second flexible body protrude in mutually opposite directions.

12. The dust-proof assembly according to claim 11, wherein the convex rib is annular.

13. The dust-proof assembly according to claim 11, wherein a longitudinal cross section of the convex rib is a cone-shaped or a conical-frustum shaped.

14. The dust-proof assembly according to claim 1, wherein the dust-proof net is disposed with a plurality of guide holes, and the plurality of through holes are staggered with the plurality of guide holes.

15. The dust-proof assembly according to claim 1, wherein the dust-proof net is disposed with a plurality of guide holes, and the plurality of through holes corresponds to the plurality of guide holes in one-by-one manner.

16. An electronic device, comprising:
a housing, disposed with a sound hole;
an electroacoustic component, disposed in the housing and configured to transmit sound through the sound hole; and
the dust-proof assembly according to claim 1, disposed in the housing, wherein the flexible sealing body is connected to the housing, and the dust-proof net is disposed facing towards the sound hole and completely covers the sound hole.

17. The electronic device according to claim 16, wherein the housing comprises a middle plate and a frame, the frame is surrounded on the middle plate and connected to the middle plate, an inner surface of the frame is formed with a groove, the sound hole is defined on the frame and connected to the groove, and the dust-proof assembly is at least partially disposed in the groove.

18. The electronic device according to claim 16, further comprising a bracket, the bracket is disposed in the housing, and the electroacoustic component is assembled on the bracket.

19. The electronic device according to claim 16, wherein the housing comprises a middle plate and a frame, the frame is surrounded on the middle plate and connected to the middle plate, the sound hole is defined on the frame, the sound hole comprises a first hole portion and a second hole portion intercommunicated with each other, the first hole portion penetrates an outer surface of the frame, the second hole portion penetrates an inner surface of the frame, and an extension direction of the first hole portion is bent relative to the second hole portion.

20. A smart watch, comprising:
a housing, disposed with a sound hole;
an electroacoustic component, disposed in the housing and configured to transmit sound through the sound hole; and
the dust-proof assembly according to claim 1, disposed in the housing, wherein the flexible sealing body is connected to the housing, and the dust-proof net is disposed facing towards the sound hole and completely covers the sound hole.
